(19) United States
(12) Patent Application Publication
(10) Pub. No.: US 2022/0083870 A1
(43) Pub. Date: Mar. 17, 2022

(54) Training in Communication Systems

(71) Applicant: Nokia Technologies OY, Espoo (FI)

(72) Inventors: Faycal AIT AOUDIA, Saint-Cloud (FR); Jakob HOYDIS, Paris (FR)

(21) Appl. No.: 17/421,462

(22) PCT Filed: Jan. 18, 2019
(86) PCT No.: PCT/EP2019/051282

§ 371 Date: Jul. 8, 2021

(51) Int. Cl. G06N 3/08; G06N 3/04; G06N 3/063

(52) U.S. Cl. CPC G06N 3/086; G06N 3/063; G06N 3/0454

(57) ABSTRACT

An apparatus, method and computer program is described including evaluating some or all of a current population of algorithms according to a metric, each algorithm of the population implementing a transmission system; selecting a subset of the algorithms of the current population based on the metric; generating an updated population of algorithms from said subset; and repeating the evaluating, selecting and generating, based on the updated population, until a first condition is reached.

### FIELD

The present specification relates to training in communication systems.

### BACKGROUND

A simple communications system includes a transmitter, a transmission channel, and a receiver. The design of such communications systems may involve the separate design and optimisation of each part of the system. An alternative approach is to consider the entire communication system as a single system and to seek to optimise the entire system. Although some attempts have been made in the prior art, there remains scope for further developments in this area.

### SUMMARY

In a first aspect, this specification describes an apparatus comprising: means for evaluating some or all of a current population of algorithms according to a metric, each algorithm of the population implementing a transmission system, wherein the transmission system comprises a transmitter, a channel and a receiver, wherein the transmitter includes a transmitter algorithm (e.g. comprising a transmitter neural network) having at least some trainable weights and the receiver includes a receiver algorithm (e.g. comprising a receiver neural network) having at least some trainable weights; means for selecting a subset of the algorithms of the current population based on the metric; means for generating an updated population of algorithms from said subset; and means for repeating the evaluating, selecting and generating, based on the updated population, until a first condition is reached. The total number of algorithms in the current and updated populations of algorithm may be the same. Said populations of algorithms may comprise neural networks.

Some embodiments may comprise means for selecting one algorithm of said updated population of algorithms, when said first condition has been reached. The selected algorithm may be the best performing algorithm of the population (according to some metric, e.g. the metric referred to above). The selected algorithm may be used as the algorithm implementing the transmission system.

Some embodiments provide means for generating an initial population of algorithms and means for setting said initial population as a first instance of said current population.

The means for evaluating some or all of the current population of algorithms may comprise means for computing a fitness of said algorithms. The fitness of said algorithms may be computed using a loss function. The loss function may be implemented, for example, by letting each instance of the communication system transmit a large number of known messages and calculating an average loss.

The means for evaluating some or all of the current population of algorithms may comprise means for computing a novelty of said algorithms. The novelty of said algorithms may be computed by determining a distance between algorithms of the population. The said distance may be a behaviour distance. The distance may be computed from the trainable weights, output or performance of the algorithms.

The means for selecting the subset of the algorithms of the current population may comprise means for selecting one or more optimum algorithms of the population according to said metric (e.g. selecting the best K options).

The updated population of algorithms may include an algorithm evaluated by the means for evaluating said some or all of the current population of algorithms as most meeting said metric.

The means for generating an updated population of algorithms from said subset may comprise generating one or more new algorithms from the subset of algorithms. For example, the new algorithm(s) may be generated based on an evolution operator. The newly generated algorithms may be close to existing (selected) algorithms. For example, perturbations of existing algorithms may be used to generate new algorithms.

At least some of the weights of the algorithms may comprise quantized weights, wherein said quantized weights can only take values within a codebook having a finite number of entries. The quantized weights may be expressed using fixed point arithmetic.

The first condition may be met when a best performing one of said current or updated population of algorithms (e.g. as evaluated by the means for evaluating said some or all of the current population of algorithms) reaches a predefined performance criterion according to said metric. Alternatively, or in addition, the first condition may comprise a defined number of iterations.

The means for generating an updated population of algorithms from said subset may modify one or more parameters and/or one or more structures of one or more of said subset of algorithms of said current population.

The said means may comprise: at least one processor; and at least one memory including computer program code, the at least one memory and the computer program configured, with the at least one processor, to cause the performance of the apparatus.

In a second aspect, this specification describes a method comprising: evaluating some or all of a current population of algorithms (e.g. neural networks) according to a metric, each algorithm of the population implementing a transmission system, wherein the transmission system comprises a transmitter, a channel and a receiver, wherein the transmitter includes a transmitter algorithm (e.g. comprising a transmitter neural network) having at least some trainable weights and the receiver includes a receiver algorithm (e.g. comprising a receiver neural network) having at least some trainable weights; selecting a subset of the algorithms of the current population based on the metric; generating an updated population of algorithms from said subset; and repeating the evaluating, selecting and generating, based on the updated population, until a first condition is reached. The total number of algorithms in the current and updated populations of algorithm may be the same.

The method may include selecting one algorithm of said updated population of algorithms, when said first condition has been reached. The selected algorithm may be the best performing algorithm of the population (e.g. according to the metric referred to above). The selected algorithm may be used as the algorithm implementing the transmission system.

The method may include generating an initial population of algorithms and setting said initial population as a first instance of said current population.

Evaluating some or all of the current population of algorithms may comprise at least one of: computing a fitness of said algorithms and computing a novelty of said algorithms. The fitness of said algorithms may be computed using a loss function. The loss function may be implemented, for example, by letting each instance of the communication system transmit a large number of known messages and calculating an average loss.

Evaluating some or all of the current population of algorithms may comprise computing a novelty of said algorithms. The novelty of said algorithms may be computed by determining a distance (e.g. a behaviour distance) between algorithms of the population.

Selecting the subset of the algorithms of the current population may comprise selecting one or more optimum algorithms of the population according to said metric (e.g. selecting the best K options).

The updated population of algorithms may include an algorithm evaluated as most meeting said metric.

Generating an updated population of algorithms from said subset may comprise generating one or more new algorithms from the subset of algorithms. For example, the new algorithm(s) may be generated based on an evolution operator. The newly generated algorithms may be close to existing (selected) algorithms. For example, perturbations of existing algorithms may be used to generate new algorithms.

At least some of the weights of the algorithms may be quantized weights, wherein said quantized weights can only take values within a codebook having a finite number of entries.

The first condition may be met when a best performing one of said current or updated population of algorithms reaches a predefined performance criterion according to said metric. Alternatively, or in addition, the first condition may comprise a defined number of iterations.

Generating an updated population of algorithms from said subset may comprise modifying one or more parameters and/or one or more structures of one or more of said subset of algorithms of said current population.

In a third aspect, this specification describes any apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: evaluate some or all of a current population of algorithms (e.g. neural networks) according to a metric, each algorithm of the population implementing a transmission system, wherein the transmission system comprises a transmitter, a channel and a receiver, wherein the transmitter includes a transmitter algorithm (e.g. comprising a transmitter neural network) having at least some trainable weights and the receiver includes a receiver algorithm (e.g. comprising a receiver neural network) having at least some trainable weights; select a subset of the algorithms of the current population based on the metric; generate an updated population of algorithms from said subset; and repeat the evaluating, selecting and generating, based on the updated population, until a first condition is reached. The total number of algorithms in the current and updated populations of algorithm may be the same.

In a sixth aspect, this specification describes a computer-readable medium (such as a non-transitory computer readable medium) comprising program instructions stored thereon for performing at least the following: evaluating some or all of a current population of algorithms (e.g. neural networks) according to a metric, each algorithm of the population implementing a transmission system, wherein the transmission system comprises a transmitter, a channel and a receiver, wherein the transmitter includes a transmitter algorithm (e.g. comprising a transmitter neural network) having at least some trainable weights and the receiver includes a receiver algorithm (e.g. comprising a receiver neural network) having at least some trainable weights; selecting a subset of the algorithms of the current population based on the metric; generating an updated population of algorithms from said subset; and repeating the evaluating, selecting and generating, based on the updated population, until a first condition is reached. The total number of algorithms in the current and updated populations of algorithm may be the same.

In a seventh aspect, this specification describes an apparatus comprising: at least one processor; and at least one memory including computer program code which, when executed by the at least one processor, causes the apparatus to: evaluate some or all of a current population of algorithms (e.g. neural networks) according to a metric, each algorithm of the population implementing a transmission system, wherein the transmission system comprises a transmitter, a channel and a receiver, wherein the transmitter includes a transmitter algorithm (e.g. comprising a transmitter neural network) having at least some trainable weights and the receiver includes a receiver algorithm (e.g. comprising a receiver neural network) having at least some trainable weights; select a subset of the algorithms of the current population based on the metric; generate an updated population of algorithms from said subset; and repeat the evaluating, selecting and generating, based on the updated population, until a first condition is reached. The total number of algorithms in the current and updated populations of algorithm may be the same.

In an eighth aspect, this specification describes an apparatus (such as a control system) comprising: a first control module for evaluating some or all of a current population of algorithms according to a metric, each algorithm of the population implementing a transmission system, wherein the transmission system comprises a transmitter, a channel and a receiver, wherein the transmitter includes a transmitter algorithm having at least some trainable weights and the receiver includes a receiver algorithm having at least some trainable weights; a second control module for selecting a subset of the algorithms of the current population based on the metric; a third control module for generating an updated population of algorithms from said subset; and a fourth control module for controlling repeating of the evaluating, selecting and generating, based on the updated population, until a first condition is reached.

### BRIEF DESCRIPTION OF THE DRAWINGS

Example embodiments will now be described, by way of non-limiting examples, with reference to the following schematic drawings, in which:

FIG. 1 is a block diagram of a communication system in accordance with an example embodiment;

FIG. 2 is a flow chart showing an algorithm in accordance with an example embodiment;

FIG. 3 is a flow chart showing an algorithm in accordance with an example embodiment;

FIG. 4 is a block diagram of a system in accordance with an example embodiment;

FIG. 5 is a flow chart showing an algorithm in accordance with an example embodiment;

FIG. 6 is a block diagram of a components of a system in accordance with an example embodiment; and

FIGS. 7A and 7B show tangible media, respectively a removable memory unit and a compact disc (CD) storing computer-readable code which when run by a computer perform operations according to embodiments.

### DETAILED DESCRIPTION

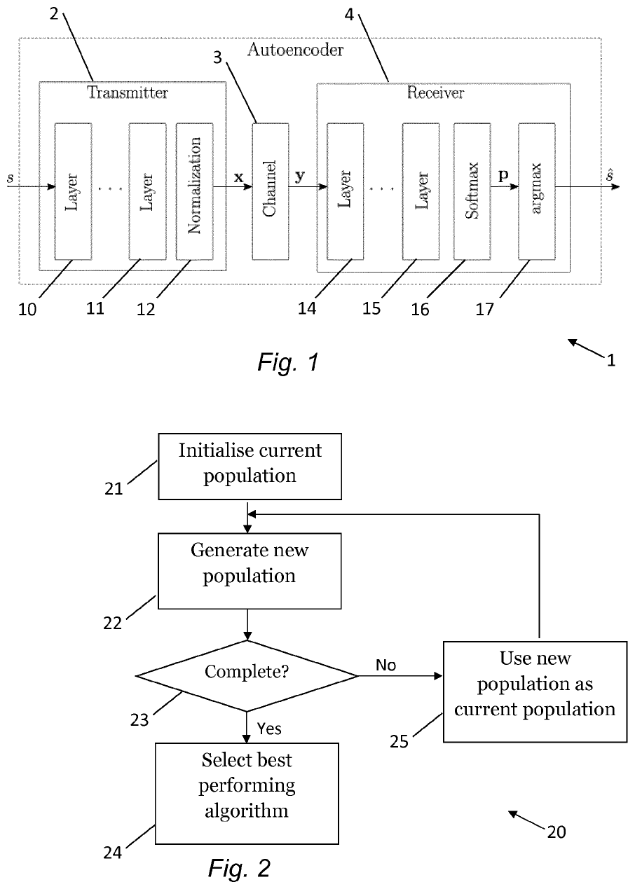

FIG. 1 is a block diagram of an example communication system, indicated generally by the reference numeral 1, in which example embodiments may be implemented. The system 1 includes a transmitter 2, a channel 3 and a receiver 4. Viewed at a system level, the system 1 converts an input symbol (s) (also called a message) received at the input to the transmitter 2 into an output symbol (ŝ) at the output of the receiver 4.

The transmitter 2 implements a transmitter algorithm. Similarly, the receiver 4 implements a receiver algorithm. As described in detail below, the algorithms of the transmitter 2 and the receiver 4 are trained in order to optimise the performance of the system 1 as a whole.

As discussed further below, the transmitter 2 may include a dense layer of one or more units 10, 11 (e.g. including one or more neural networks) and a normalization module 12. The dense layers 10, 11 may include an embedding module. The modules within the transmitter 2 are provided by way of example and modifications are possible.

Similarly, the receiver 4 may include a dense layer of one or more units 14, 15 (e.g. including one or more neural networks), a softmax module 16 and an arg max module 17. As described further below, the output of the softmax module is a probability vector that is provided to the input of an arg max module 17. The modules within the receiver 4 are provided by way of example and modifications are possible.

The system 1 therefore provides an autoencoder implementing an end-to-end communication system. The autoencoder can be trained with respect to an arbitrary loss function that is relevant for a certain performance metric, such as block error rate (BLER). (The terms ‘autoencoder’ and ‘communication system’ are both used below to describe the system 1.)

One obstacle to practical hardware implementation of the communication system (or autoencoder) 1 is the high memory requirement and computational complexity of the involved neural networks. Hardware acceleration may be provided to achieve reasonable inference time. However, graphical processing units (GPUs) that can be used to accelerate neural network evaluations come at a high monetary and energy cost that may not be viable in many communication systems.

By way of example, neural networks (or some other parametric algorithm) may be trained and exploited on computationally powerful platforms with graphic processing units (GPU) acceleration, supporting high precision floating point arithmetic (e.g. 32-bit or 64-bit floating point arithmetic). Such hardware may not be available for some communication systems. Accordingly, the neural networks implementing the transmitter 2 and the receiver 4 of the system 1 may be compressed to meet practical constraints. This may be achieved by using a more compact representation of neural network parameters, at the cost of reduced precision. For example, as described further below, compression of weights and/or biases of the neural networks may be achieved through quantization, such that the weights are forced to take values within a codebook with a finite number of entries (e.g. at a lower precision that that provided by a training module). In extreme cases, each weight may take a binary value (e.g. either −1 or +1).

One method for quantizing the weights of a neural network (or some other algorithm) is to use K-bit fixed point arithmetic, instead of using a floating point arithmetic (such as 32-bits or 64-bits floating point arithmetic), with K typically being smaller than 32. Combining the principles of quantization and the use of fixed point arithmetic not only results in using fewer bits to represent the weights of the neural networks described herein, but can also reduce the complexity of arithmetic operators.

Using K-bits fixed point arithmetic, with K_{E} bits used for the integer part and K_{F} bits used for the fractional part (such that K_{E}+K_{F}=K), a weight w is represented by:

$$w = {\sum }_{i = 0}^{{K}_{E} - 1} {w}_{e , i} {2}^{i} + {\sum }_{j = 1}^{{K}_{F}} {w}_{f , j} {2}^{- j}$$

where w_{e,i} and w_{f,j} take values in {0,1}. The number of bits K, as well as the sizes of the integer and fractional parts K_{E} and K_{F} are fixed. The scalar w is represented by a K+1 bit word (wₛ, w_{e,0}, . . . , wₑK_{E-1}, w_{f,1}, . . . , w_{f,K}_{_{F}}), where wₛ is a sign bit (i.e. a bit indicating the sign of the weight).

In one embodiment, the transmitter 2 seeks to communicate one out of M possible messages s∈ [symbol] ={1, 2, . . . , M} to the receiver 4. To this end, the transmitter 2 sends a complex-valued vector representation x=x(s∈ [symbol] ⁿ of the message through the channel 3. Generally, the transmitter hardware imposes constraints on x, e.g. an energy constraint ∥x∥₂²≤n, an amplitude constraint ∥xᵢ∥≤1∀i, or an average power constraint [symbol] [|xᵢ|²]≤1∀i. The channel 3 is described by the conditional probability density function (pdf) p(y|x), where y∈ [symbol] ⁿ denotes the received signal. Upon reception of y, the receiver produces the estimate ŝ of the transmitted message s.

The message index s may be fed into an embedding module, embedding: [symbol] [symbol] [symbol] ⁿ^{_{emb}}, that transforms s into an n_{emb}-dimensional real-valued vector.

The embedding module may be followed by several dense neural network (NN) layers 10, 11 with possible different activation functions (such as ReLU, tanh, signmoid, linear etc.). The final layer of the neural network may have has 2n output dimensions and a linear activation function. If no dense layer is used, n_{emb}=2n.

The output of the dense layers 10, 11 may be converted to a complex-valued vector through the mapping [symbol] 2 [symbol] : [symbol] ²ⁿ [symbol] [symbol] ⁿ, which could be implemented as [symbol] 2 [symbol] (z)=z₀ⁿ⁻¹+jzₙ²ⁿ⁻¹. (This is not shown and is a purely optional step.)

A normalization is applied by the normalization module 12 that ensures that power, amplitude or other constraints are met. The result of the normalization process is the transmit vector x of the transmitter 2 (where x∈ [symbol] ²ⁿ). As noted above, modifications may be made to the transmitter 2, for example the order of the complex vector generation and the normalization could be reversed.

The transmitter 2 defines the following mapping:

TX: [symbol] [symbol] [symbol] ²ⁿ, [symbol] =(0, . . . ,M−1).

In other words, TX maps an integer from the set [symbol] to a 2n-dimensional real-valued vector. One example mapping is described above. Other neural network architectures are possible and the illustration above services just as an example.

As discussed above, the receiver 4 includes a dense layer of one or more units 14, 15 (e.g. including one or more neural networks), a softmax module 16 and an arg max module 17.

If the channel output vector y∈ [symbol] ⁿ is complex-valued, it may be transformed by the receiver 4 into a real-valued vector of 2n dimensions through the mapping [symbol] 2 [symbol] : [symbol] [symbol] [symbol] ²ⁿ, which could be implemented as [symbol] 2 [symbol] (z)=[ [symbol] {z}^{T}, [symbol] {z}^{T}]^{T}. This step is not necessary for real-valued channel outputs y∈ [symbol] ²ⁿ.

The result is fed into the one or more layers 14, 15, which layers may have different activation functions such as ReLU, tanh, sigmoid, linear, etc. The last layer may have M output dimensions to which a softmax activation is applied (by softmax module 16). This generates the probability vector p∈ [symbol] ^{M}, whose ith element [p]ᵢ can be interpreted as Pr(s=i|y). A hard decision for the message index is obtained as ŝ=arg max(p) by arg max module 17.

The transmitter 2 and the receiver 4 may be implemented as neural networks having parameter vectors θ_{T} and θ_{R} respectively. If a differential channel model is available, then the channel model can be used as an intermediate non-trainable layer, such that the entire communication system 1 can be seen as a single neural network with parameters vector θ=(θ_{T}, θ_{R}), which defines the mapping:

$${f}_{θ} : ℳ ↦ \{ p ∈ {ℝ}_{+}^{M} \vert {\sum }_{i = 1}^{M} {p}_{i} = 1 \} \times ℳ$$

In some arrangements, the autoencoder 1 may be trained in a supervised manner using stochastic gradient descent (SGD). However, the use of stochastic gradient descent is difficult for an autoencoder with quantized weights, which take values in a discrete space.

FIG. 2 is a flow chart showing an algorithm, indicated generally by the reference numeral 20, in accordance with an example embodiment. The algorithm 20 uses principles of evolutionary computation to train an algorithm, such as a neural network (e.g. neural networks having quantized weights) implementing communication systems.

The algorithm 20 starts at operation 21, where a population [symbol] of neural networks (or some other algorithms) implementing end-to-end communication systems (or autoencoders) such as the autoencoder 1 are initialised. This can be achieved by generating parameters θ_{T} implementing transmitter neural networks and parameters θ_{R} implementing receiver neural networks according to some probability distribution over the possible weights values. The operation 21 may generate the parameters randomly from possible quantized weights.

At operation 22, a new population is generated from the initial population. As described further below, generating a new population may include selecting a subset of the initial/current population and generating a new population from the subset. The selection is made according to a metric (such as a loss function). Some example metrics are discussed further below.

With a new population generated, it is determined at operation 23 whether or not the algorithm 20 is complete. If so, the algorithm moves to 24. Otherwise, the algorithm moves to operation 25.

The algorithm 20 may be deemed to be complete when a condition is reached; example conditions include a predefined performance level or a defined number of iterations. In one embodiment, the condition is deemed to have been reached when the best performing one (according to some metric) of the population of neural networks generated in the most recent iteration of the operation 22 reaches a predefined performance criterion according to said metric. The skilled person will be aware of other example conditions that could be used in the operation 23.

At operation 25, the new population is used as the current population and the algorithm returns to operation 22, where a new population is generated (using the population generated in the previous iteration of the operation 22 as the starting point).

The operations 22, 23 and 25 are repeated until the algorithm 20 is deemed to be complete. When the algorithm is deemed to be complete, the best performing neural network of the population of neural networks generated in the most recent iteration of the operation 22 is selected (in operation 24) and used as the output of the algorithm 20. In this way, the algorithm 20 can generate a neural network for use, for example, in the autoencoder 1 described above.

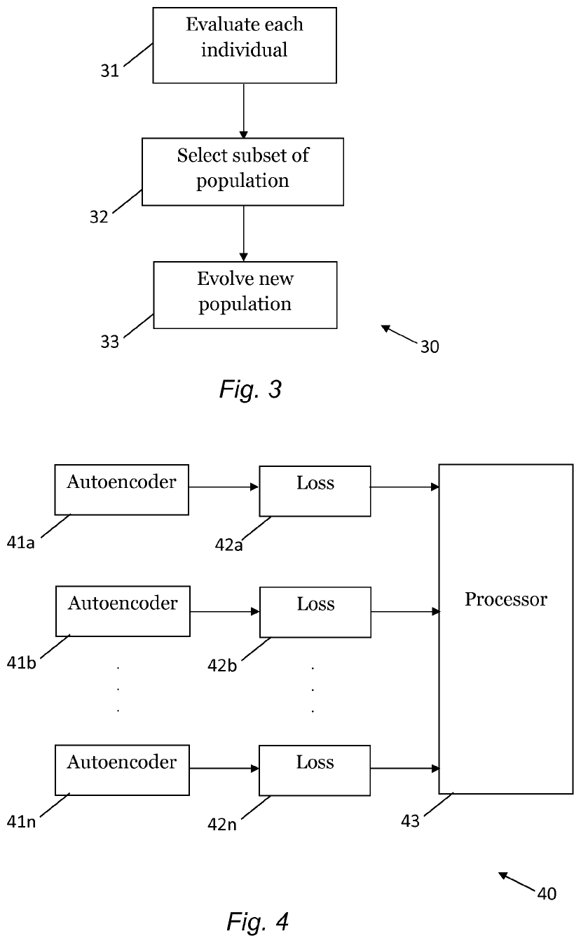

FIG. 3 is a flow chart showing an algorithm, indicated generally by the reference numeral 30, in accordance with an example embodiment. The algorithm 30 is an example implementation of the operation 22 of the algorithm 20 in which a new population is generated from a current population.

The current population comprises a population [symbol] of P neural networks (also referred to as individuals). The algorithm 30 seeks to ‘evolve’ the population of neural networks such that, on average, the population gets better with respect to a loss function on each iteration of the algorithm 30.

The algorithm 30 starts at operation 31, where some or all of the individuals within the population [symbol] are evaluated according to a metric. For example, each individual within a population may be evaluated with respect of a loss function L to compute a fitness fᵢ of that population. The fitness may be calculated according to the formula: fᵢ=−L(pᵢ) for all pᵢ∈ [symbol] .

The operation 31 may be implemented, for example, by letting each end-to-end communication system (or autoencoder) transmit a large number of known messages for which the average loss L(pᵢ) is calculated using the formula

$$L = \frac{1}{N} {\sum }_{i = 1}^{N} - log ( {[ {p}_{i} ]}_{{s}_{i}} ) ,$$

where −log[pᵢ]ₛ_{ᵢ}) is the categorical cross entropy between an input message and the output vector pᵢ.

At operation 32, a subset of the neural networks of the current population is selected based on the metric (e.g. the fitness referred to above). The selection may, for example, seek to select the optimum neural networks of the population (such as the best K options) according to said metric. Alternative approaches exist, such as selecting less optimum neural networks (according to the metric) for exploration purposes (e.g. to reduce the likelihood of approaching a local minima), as discussed further below. Moreover, algorithms other than neural networks may be used.

In an example implementation of the operation 32, a subset [symbol] is selected, such that [symbol] =Θ( [symbol] , {fᵢ}ᵢ), such that [symbol] ⊂ [symbol] , according to the fitness of the individuals {fᵢ}ᵢ.

At operation 33, an updated population of neural networks is generated (or ‘evolved’) from the subset selected in operation 32. For example, a new population may be generated from the subset [symbol] selected in the operation 32 as follows:

[symbol]

=Ξ( [symbol] ₜ), where Ξ is an evolution operator.

The total number of neural networks in the current and updated populations may be the same. In one example, the updated population includes the best performing neural network from the current population (e.g. the neural network most meeting the relevant metric), with all other members of the updated population being generated/evolved from said subset. For example, assume that a population includes wo neural networks. The 10 best performing neural networks of the population may be used to generate 99 neural networks, with the updated population including the 99 newly generated neural networks and the best performing neural network of the current population.

Thus, on each iteration of the operation 22 of the algorithm 20, a new updated population of neural networks is generated.

The evolution operator Ξ described above can take many forms. For example, if it assumed that all of the neural networks of the population share the same architecture, with W trainable weights, then a neural network p can be uniquely represented by a W-dimensional real vector [symbol] (p)∈ [symbol] ^{W} reconstructed by vectorization of its trainable weights.

The vector [symbol] (p) may be referred to as a genome of the individual p (using genetic algorithm terminology).

A simple way to generate new individuals is to apply random perturbations to the genomes of selected individuals. Thus, a new individual p′can be obtained from another individual p as follows: p′= [symbol] ⁻¹( [symbol] (p)+w), where w is a random perturbation and [symbol] ⁻¹ is the mapping between a vector of weights and its uniquely corresponding neural network. Addition could be taken on a Galois field. Such perturbations of individual genomes can be referred to as mutations (again, using genetic algorithm terminology). It is also possible to perform crossovers, by combining multiple selected individuals to produce a new one.

In some embodiments of the algorithms 20 and 30, the weights of the neural networks are quantized, such that said weights can only take values within a codebook having a finite number of entries (as discussed above). The quantized weights may be expressed used fixed point arithmetic, as discussed above.

The evaluation of individuals within a population of neural networks (as described, for example, with respect to the algorithm 30) can be conducted in parallel; for example, by either instantiating a plurality of members of the population on a different physical hardware setup or by simulating the neural networks of the population in software. By way of example, FIG. 4 is a block diagram of a system, indicated generally by the reference numeral 40, in accordance with an example embodiment comprising a plurality of autoencoders 41a, 41b . . . 41n (which may be hardware implementations of autoencoders or software simulations). Each autoencoder is a transmission system comprising a transmitter, a channel and a receiver (such as the autoencoder 1), that is viewed as a single neural network (or some other algorithm) with parameters vector θ (where θ is derived from transmitter and receiver neural network parameters). Thus, each of the autoencoders 41a, 41b . . . 41n is an example of an individual within a population of neural networks.

A loss function module 42a generates a loss function from the first autoencoder 41a. Similar loss functions modules 42b to 42n generate loss functions for the autoencoders 41b to 41n. The outputs of the loss function modules 42a to 42n are provided to a processor 43, which processor implements the operation 32 by selecting a subset of the population of autoencoders based on the outputs of the loss function modules.

In the embodiments described above, the operation 22 of the algorithm 20 is implemented by considering the fitness of neural networks within a population of neural networks. This is not essential to all embodiments.

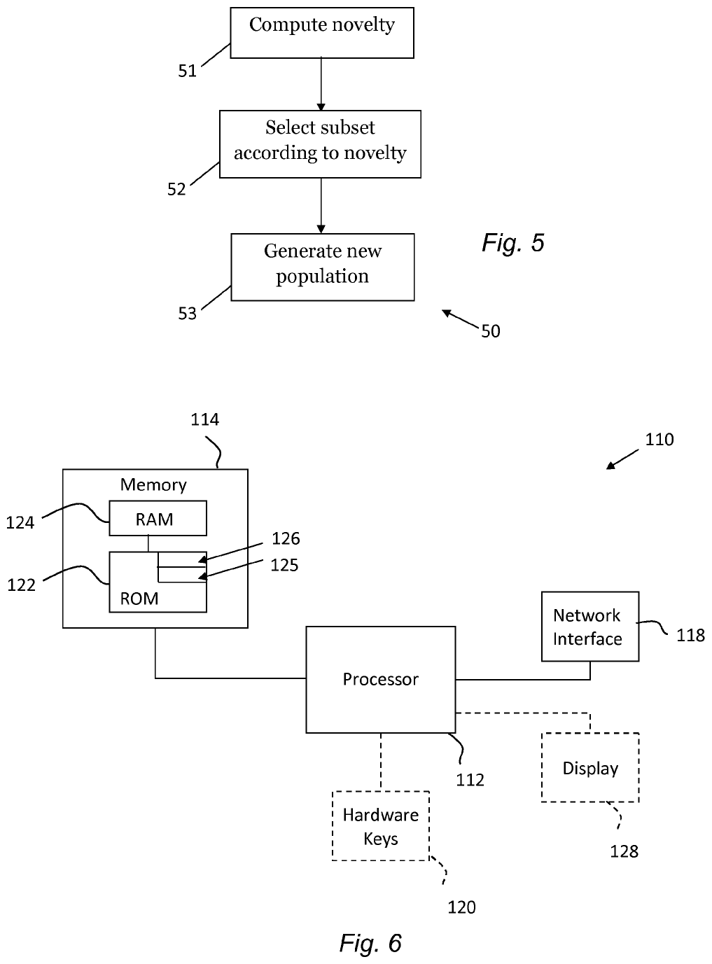

FIG. 5 is a flow chart showing an algorithm, indicated generally by the reference numeral 50, in accordance with an example embodiment. The algorithm 50 is an example implementation of the operation 22 in which so-called novelty is considered, instead of fitness. The novelty-based algorithm (which is described in detail below) includes the definition of a ‘behaviour characteristic’, which measures behaviour of a neural network (or some other algorithm), and a ‘behaviour distance’, which measures the distance between the behaviours of different neural networks or algorithms. The behaviour may, for example, be computed from the trainable weights, output or performance of the neural networks of a population.

The algorithm 50 starts at operation 51, where the novelty of a population is computed. That population may be the initial population generated in the operation 21 or the new population generated in the previous iteration of the operation 22 of the algorithm 20 described above. We denote by Γ the function which measures the novelty of an individual with regards to the current and previous populations. To do so, the defined behaviour characteristics and behaviour distances are used. Thus, for each neural network of a population [symbol] , novelty is computed as follows: nᵢ=Γ(pᵢ, [symbol] , [symbol] , . . . [symbol] ) for all pᵢ∈ [symbol] .

At operation 52, a subset of the population is selected according to novelty. In this way, the behavioural novelty of individuals within a population is rewarded, rather than the fitness of individuals. Although counter-intuitive, this subset selection process has been found to give good results.

In the operation 52, the subset may be defined as [symbol] =Θ( [symbol] , {nᵢ}ᵢ), such that [symbol] ⊂ [symbol] according to the novelty of the individuals {nᵢ}ᵢ.

At operation 53, a new population is selected from the subset selected in the operation 52. The new population may be given by [symbol] =Ξ( [symbol] ₜ), where Ξ is an evolution operator.

As noted above, the operation 53 may restore the size of the population (e.g. to P).

The behaviour characteristics discussed above may be domain specific. In the case of autoencoders implementing end-to-end communication systems (such as the autoencoder 1), the constellation generated by the encoder may be used as a behaviour characteristic. For example, the behaviour characteristic could be the n-by-M matrix, in which the ith column corresponds to the complex value representation of the message i, where x(i)∈ [symbol] ⁿ. The behaviour distance can therefore be any matrix norm. For example, given two behaviour characteristics X₁ and X₂, the behaviour distance could be ∥X₁-X₂∥_{F} (where ∥X∥_{F} is the Frobenius norm of X).

The algorithm 30 described above selects a subset by considering fitness. The algorithm 50 described above selects a subset by considering novelty. It is also possible to combine aspects of the two algorithms, such that the subset is selected by considering aspects of both fitness and novelty. For example, one may generate a new population by keeping both the K-best performing (according to some metric) and the L-most novel individuals and by creating mutations of the K best performing and the L most different individuals.

For completeness, FIG. 6 is a schematic diagram of components of one or more of the modules described previously (e.g. the transmitter or receiver neural networks), which hereafter are referred to generically as processing systems 110. A processing system 110 may have a processor 112, a memory 114 closely coupled to the processor and comprised of a RAM 124 and ROM 122, and, optionally, hardware keys 120 and a display 128. The processing system 110 may comprise one or more network interfaces 118 for connection to a network, e.g. a modem which may be wired or wireless.

The processor 112 is connected to each of the other components in order to control operation thereof.

The memory 114 may comprise a non-volatile memory, a hard disk drive (HDD) or a solid state drive (SSD). The ROM 122 of the memory 114 stores, amongst other things, an operating system 125 and may store software applications 126. The RAM 124 of the memory 114 is used by the processor 112 for the temporary storage of data. The operating system 125 may contain code which, when executed by the processor, implements aspects of the algorithms 20, 30 and 50.

The processor 112 may take any suitable form. For instance, it may be a microcontroller, plural microcontrollers, a processor, or plural processors.

The processing system 110 may be a standalone computer, a server, a console, or a network thereof.

In some embodiments, the processing system 110 may also be associated with external software applications. These may be applications stored on a remote server device and may run partly or exclusively on the remote server device. These applications may be termed cloud-hosted applications. The processing system no may be in communication with the remote server device in order to utilize the software application stored there.

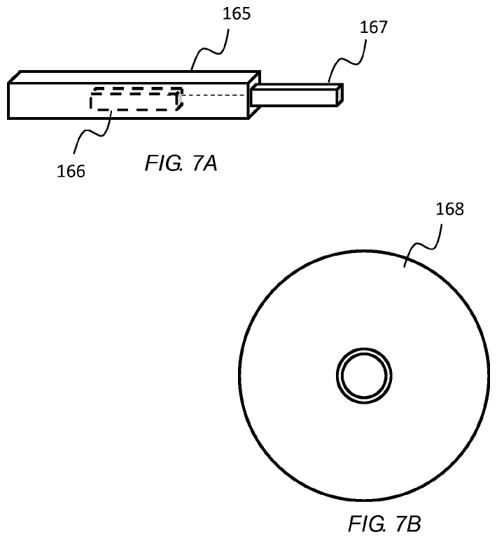

FIGS. 7A and 7B show tangible media, respectively a removable memory unit 165 and a compact disc (CD) 168, storing computer-readable code which when run by a computer may perform methods according to embodiments described above. The removable memory unit 165 may be a memory stick, e.g. a USB memory stick, having internal memory 166 storing the computer-readable code. The memory 166 may be accessed by a computer system via a connector 167. The CD 168 may be a CD-ROM or a DVD or similar. Other forms of tangible storage media may be used.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow diagram of FIGS. 2, 3 and 5 are examples only and that various operations depicted therein may be omitted, reordered and/or combined.

The example embodiments have generally been described above with reference to populations of neural networks. This is not essential to all embodiments. For example, other forms of algorithms (such as a parametric algorithm) may be used. Moreover, although example embodiments are described in which trainable parameters of the algorithm (e.g. parameters of a neural network) are updated, this is not essential to all embodiments. For example, a population of algorithms may be updated by updating one or more parameters and/or one or more structures of one or more of the algorithms of a population.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising circuitry configured to cause:
evaluating some or all of a current population of algorithms according to a metric, each algorithm of the population implementing a transmission system, wherein the transmission system comprises a transmitter, a channel and a receiver, wherein the transmitter includes a transmitter algorithm having at least some trainable weights and the receiver includes a receiver algorithm having at least some trainable weights;
selecting a subset of the algorithms of the current population based on the metric;
generating an updated population of algorithms from said subset; and
repeating the evaluating, selecting and generating, based on the updated population, until a first condition is reached.

2. An apparatus as claimed in claim 1, where the circuitry is further configured to cause selecting one algorithm of said updated population of algorithms, when said first condition has been reached.

3. An apparatus as claimed in claim 1, where the circuitry is further configured to cause generating an initial population of algorithms and setting said initial population as a first instance of said current population.

4. An apparatus as claimed in claim 1, wherein the circuitry configured to cause evaluating some or all of the current population of algorithms comprises circuitry configured to cause computing a fitness of said algorithms.

5. An apparatus as claimed in claim 4, wherein the fitness of said algorithms is computed using a loss function.

6. An apparatus as claimed in claim 1, wherein the circuitry configured to cause evaluating some or all of the current population of algorithms comprises circuitry configured to cause computing a novelty of said algorithms.

7. An apparatus as claimed in claim 6, wherein the novelty of said algorithms is computed with determining a distance between algorithms of the population.

8. An apparatus as claimed in claim 1, wherein the circuitry configured to cause selecting the subset of the algorithms of the current population comprises circuitry configured to cause selecting one or more optimum algorithms of the population according to said metric.

9. An apparatus as claimed in claim 1, wherein the updated population of algorithms includes an algorithm evaluated with the circuitry configured to cause evaluating said some or all of the current population of algorithms as most meeting said metric.

10. An apparatus as claimed in claim 1, wherein the circuitry configured to cause generating an updated population of algorithms from said subset comprises circuitry configured to cause generating one or more new algorithms from the subset of algorithms.

11. An apparatus as claimed in claim 1, wherein at least some of the weights of the algorithms are quantized weights, wherein said quantized weights can only take values within a codebook having a finite number of entries.

12. An apparatus as claimed in claim 1, wherein the first condition is met when a best performing one of said current or updated population of algorithms reaches a predefined performance criterion according to said metric.

13. An apparatus as claimed in claim 1, wherein the first condition comprises a defined number of iterations.

14. An apparatus as claimed in claim 1, wherein said circuitry configured to cause generating an updated population of algorithms from said subset is configured to modify one or more parameters and/or one or more structures of one or more of said subset of algorithms of said current population.

15. An apparatus as claimed in claim 1, wherein said populations of algorithms comprise neural networks.

16. An apparatus as claimed in claim 1, wherein the circuitry comprise:
at least one processor; and
at least one non-transitory memory including computer program code.

17. A method comprising:
evaluating some or all of a current population of algorithms according to a metric, each algorithm of the population implementing a transmission system, wherein the transmission system comprises a transmitter, a channel and a receiver, wherein the transmitter includes a transmitter algorithm having at least some trainable weights and the receiver includes a receiver algorithm having at least some trainable weights;
selecting a subset of the algorithms of the current population based on the metric;
generating an updated population of algorithms from said subset; and
repeating the evaluating, selecting and generating, based on the updated population, until a first condition is reached.

18. A method as claimed in claim 17, further comprising selecting one algorithm of said updated population of algorithms, when said first condition has been reached.

19. A method as claimed in claim 17, wherein evaluating some or all of the current population of algorithms comprises at least one of: computing a fitness of said algorithms or computing a novelty of said algorithms.

20. A method as claimed in claim 17, wherein at least some of the weights of the algorithms are quantized weights, wherein said quantized weights can only take values within a codebook having a finite number of entries.

21. A computer readable medium comprising program instructions stored thereon for performing at least the following:
evaluating some or all of a current population of algorithms according to a metric, each algorithm of the population implementing a transmission system, wherein the transmission system comprises a transmitter, a channel and a receiver, wherein the transmitter includes a transmitter algorithm having at least some trainable weights and the receiver includes a receiver algorithm having at least some trainable weights;
selecting a subset of the algorithms of the current population based on the metric;
generating an updated population of algorithms from said subset; and repeating the evaluating, selecting and generating, based on the updated population, until a first condition is reached.
